(19) United States
(12) Patent Application Publication
(10) Pub. No.: US 2026/0017765 A1
(43) Pub. Date: Jan. 15, 2026

(54) ELECTRONIC DEVICE AND OPTICAL COMPENSATION SYSTEM

(71) Applicant: Samsung Display Co., LTD., Yongin-si (KR)

(72) Inventors: HAKMO CHOI, Yongin-si (KR); SEYUN KIM, Yongin-si (KR); HYUNGWOO YIM, Yongin-si (KR); HUISU KIM, Yongin-si (KR)

(21) Appl. No.: 19/187,480

(22) Filed: Apr. 23, 2025

(30) Foreign Application Priority Data
Jul. 15, 2024 (KR) 10-2024-0092861

(51) Int. Cl. G06T 5/80; G06T 7/80; H04N 23/63

(52) U.S. Cl. CPC G06T 5/80; G06T 7/80; H04N 23/63; G06T 2207/20021

(57) ABSTRACT

Disclosed is an optical compensation system including an electronic device including a plurality of pixels and displaying an image corresponding to an input image signal, an image capture device that captures the image displayed on the electronic device and provides a captured image signal, and a deterioration optical compensator that outputs a correction data signal, which is obtained by correcting the captured image signal based on an accumulation data signal from accumulating the input image signal, and outputs a final compensation map for compensating for deterioration of the electronic device based on the correction data signal. The electronic device displays the image corresponding to the input image signal by performing a deterioration compensation operation based on the final compensation map.

This application claims priority to Korean Patent Application No. 10-2024-0092861, filed on Jul. 15, 2024, and all the benefits accruing therefrom under 35 U.S.C. § 119, the content of which in its entirety is herein incorporated by reference.

### BACKGROUND

### Field

Embodiments of the present disclosure described herein relate to an electronic device and an optical compensation system for compensating for characteristics of the electronic device.

### Description of the Related Art

An electronic device, such as, for example, a smart phone, a digital camera, a notebook computer, a navigation system, a monitor, and a smart television may provide images to users. The electronic device generates an image and provides the users with the generated image through a display screen.

The electronic device includes a plurality of pixels and driving circuits for controlling the plurality of pixels. Each of the plurality of pixels includes a light emitting element and transistors for controlling the light emitting element. The driving circuit of a pixel may include a plurality of transistors operatively connected to one another.

The electronic device may apply a data signal to a display panel. As a current corresponding to the data signal is supplied to the light emitting element, the electronic device may display a predetermined image.

When the light emitting element and transistors constituting a pixel operate for a long period of time, the characteristics of the pixel may be changed.

### SUMMARY

Embodiments of the present disclosure provide an electronic device capable of detecting and compensating for changes in pixel characteristics and an optical compensation system.

According to an embodiment, an optical compensation system includes an electronic device including a plurality of pixels and which displays an image corresponding to an input image signal, an image capture device that captures the image displayed on the electronic device and provides a captured image signal, and a deterioration optical compensator that outputs a correction data signal, which is obtained by correcting the captured image signal based on an accumulation data signal from accumulating the input image signal, and outputs a final compensation map for compensating for deterioration of the electronic device based on the correction data signal. The electronic device displays the image corresponding to the input image signal by performing a deterioration compensation operation based on the final compensation map.

In an embodiment, the deterioration optical compensator may divide the electronic device into a normal area and a deterioration area by determining a deterioration degree of each of the plurality of pixels based on the correction data signal, the accumulation data signal, and a compensation map provided from the electronic device, may generate a first compensation value for the normal area, may generate a second compensation value for the deterioration area, and may generate the final compensation map by combining the first compensation value and the second compensation value.

In an embodiment, the deterioration optical compensator may generate the first compensation value in units of blocks of the normal area based on the correction data signal. The deterioration optical compensator may generate the second compensation value in units of pixels of the deterioration area based on the correction data signal. Each block may correspond to some pixels among the plurality of pixels.

In an embodiment, the deterioration optical compensator may include a captured-image corrector that determines first deterioration pixels among the plurality of pixels based on the accumulation data signal, determines second deterioration pixels among the plurality of pixels based on the captured image signal, and outputs the correction data signal, which is obtained by correcting the captured image signal based on comparing the first deterioration pixels and the second deterioration pixels.

In an embodiment, the deterioration optical compensator may include a deterioration area analyzer that determines a deterioration degree of each of the plurality of pixels based on the correction data signal, the accumulation data signal, and a compensation map provided from the electronic device, divides the electronic device into a normal area and a deterioration area, and outputs a data signal corresponding to the correction data signal, a first compensator that outputs a first compensation value corresponding to the normal area, based on the data signal, a second compensator that outputs a second compensation value corresponding to the deterioration area, based on the data signal, and a final compensation map generator that generates the final compensation map by combining the first compensation value and the second compensation value.

In an embodiment, the first compensator may divide the normal area into a plurality of blocks, and may output the first compensation value corresponding to each of the plurality of blocks based on the data signal.

In an embodiment, the second compensator may output the second compensation value corresponding to each of the plurality of pixels of the deterioration area.

According to an embodiment, an optical compensation system includes an electronic device including a plurality of pixels and which displays an image corresponding to an input image signal, an image capture device that captures the image displayed on the electronic device and provides a captured image signal, and a deterioration optical compensator that outputs a correction data signal, which is obtained by correcting the captured image signal based on a feedback current signal received from the plurality of pixels, and outputs a final compensation map for compensating for deterioration of the electronic device based on the correction data signal. The electronic device displays the image corresponding to the input image signal by performing a deterioration compensation operation based on the final compensation map.

In an embodiment, the deterioration optical compensator may divide the electronic device into a normal area and a deterioration area by determining a deterioration degree of each of the plurality of pixels based on the correction data signal, the feedback current signal, and a compensation map provided from the electronic device, may generate a first compensation value for the normal area, may generate a second compensation value for the deterioration area, and may generate the final compensation map by combining the first compensation value and the second compensation value.

In an embodiment, the deterioration optical compensator may generate the first compensation value in units of blocks of the normal area based on the correction data signal. The deterioration optical compensator may generate the second compensation value in units of pixels of the deterioration area based on the correction data signal. Each block may correspond to some pixels among the plurality of pixels.

In an embodiment, the deterioration optical compensator may include a captured-image corrector that determines first deterioration pixels among the plurality of pixels based on the feedback current signal, determines second deterioration pixels among the plurality of pixels based on the captured image signal, and outputs the correction data signal, which is obtained by correcting the captured image signal based on comparing the first deterioration pixels and the second deterioration pixels.

In an embodiment, the deterioration optical compensator may include a deterioration area analyzer that determines a deterioration degree of each of the plurality of pixels based on the correction data signal, the feedback current signal, and a compensation map provided from the electronic device, divides the electronic device into a normal area and a deterioration area, and outputs a data signal corresponding to the correction data signal, a first compensator that outputs a first compensation value corresponding to the normal area, based on the data signal, a second compensator that outputs a second compensation value corresponding to the deterioration area, based on the data signal, and a final compensation map generator that generates the final compensation map by combining the first compensation value and the second compensation value.

In an embodiment, the first compensator may divide the normal area into a plurality of blocks, and may output the first compensation value corresponding to each of the plurality of blocks based on the data signal.

In an embodiment, the second compensator may output the second compensation value corresponding to each of the plurality of pixels of the deterioration area.

According to an embodiment, an electronic device includes a display panel including a plurality of pixels and a driving controller that outputs an image data signal based on an input image signal and a captured image signal corresponding to an image displayed on the display panel. The driving controller includes an image data signal accumulation unit that accumulates the image data signal and outputs an accumulation image signal, a deterioration amount prediction unit that predicts a deterioration amount of each of the plurality of pixels based on the accumulation image signal, a compensation value generation unit that generates a compensation map including a compensation value corresponding to each of the plurality of pixels based on the deterioration amount of each of the plurality of pixels, a deterioration optical compensator that outputs a correction data signal, which is obtained by correcting the captured image signal based on the accumulation data signal, and outputs a final compensation map for compensating for deterioration of the electronic device based on the correction data signal, and an image data signal output unit that converts the input image signal into the image data signal based on the compensation map and the final compensation map.

In an embodiment, the deterioration optical compensator may divide the display panel into a normal area and a deterioration area by determining a deterioration degree of each of the plurality of pixels based on the correction data signal, the accumulation data signal, and the compensation map, may generate a first compensation value for the normal area, may generate a second compensation value for the deterioration area, and may generate the final compensation map by combining the first compensation value and the second compensation value.

In an embodiment, the deterioration optical compensator may generate the first compensation value in units of blocks of the normal area based on the correction data signal. The deterioration optical compensator may generate the second compensation value in units of pixels of the deterioration area based on the correction data signal. Each block may correspond to some pixels among the plurality of pixels.

In an embodiment, the deterioration optical compensator may include a captured-image corrector that determines first deterioration pixels among the plurality of pixels based on the accumulation data signal, determines second deterioration pixels among the plurality of pixels based on the captured image signal, and outputs the correction data signal, which is obtained by correcting the captured image signal based on comparing the first deterioration pixels and the second deterioration pixels.

In an embodiment, the deterioration optical compensator may include a deterioration area analyzer that determines a deterioration degree of each of the plurality of pixels based on the correction data signal, the accumulation data signal, and a compensation map provided from the electronic device, divides the electronic device into a normal area and a deterioration area, and outputs a data signal corresponding to the correction data signal, a first compensator that outputs a first compensation value corresponding to the normal area, based on the data signal, a second compensator that outputs a second compensation value corresponding to the deterioration area, based on the data signal, and a final compensation map generator that generates the final compensation map by combining the first compensation value and the second compensation value.

In an embodiment, the first compensator may divide the normal area into a plurality of blocks, and may output the first compensation value corresponding to each of the plurality of blocks based on the data signal. The second compensator outputs the second compensation value corresponding to each of the plurality of pixels of the deterioration area.

### BRIEF DESCRIPTION OF THE FIGURES

The above and other objects and features of the present disclosure will become apparent by describing in detail embodiments thereof with reference to the accompanying drawings.

FIG. 1 is a perspective view of an electronic device, according to an embodiment of the present disclosure.

FIG. 2 is an exploded perspective view of an electronic device, according to an embodiment of the present disclosure.

FIG. 3 is a block diagram of an electronic device, according to an embodiment of the present disclosure.

FIG. 4 is an equivalent circuit diagram of a pixel, according to an embodiment of the present disclosure.

FIG. 5 is a diagram for describing an operation of a driving controller.

FIG. 6 is a drawing for describing an operation of a driving controller.

FIG. 7 is a diagram illustrating an optical compensation system, according to an embodiment of the present disclosure.

FIG. 8 is a block diagram of a deterioration optical compensator, according to an embodiment of the present disclosure.

FIG. 9A is a diagram illustrating an image displayed on an electronic device.

FIG. 9B is a drawing illustrating a captured image by an image capture device.

FIG. 10A is a diagram illustrating an image displayed on an electronic device.

FIG. 10B is a drawing illustrating an accumulation data signal of an electronic device as an image.

FIG. 10C is a drawing illustrating a captured image from an image capture device when an image illustrated in FIG. 10A is displayed on an electronic device for a long period of time and then a gray gradation image is displayed.

FIG. 10D is a diagram for describing a method for determining a deterioration area.

FIGS. 11A, 11B, and 11C are drawings illustrating images displayed on an electronic device, respectively.

FIGS. 12A, 12B, and 12C are drawings respectively illustrating images captured by an image capture device when images illustrated in FIGS. 11A, 11B, and 11C are displayed on the electronic device DD for a long period of time and then a gray gradation image is displayed.

FIG. 13 illustrates luminance of an image when a gray gradation image is displayed on an electronic device after the grayscale image illustrated in FIG. 11A is displayed for a long period of time.

FIG. 14A is a drawing illustrating a captured image generated by an image capture device when the image illustrated in FIG. 11C is displayed on an electronic device for a long period of time and then a gray gradation image is displayed.

FIG. 14B is a drawing illustrating a captured image generated by an image capture device when an image illustrated in FIG. 11C is displayed on an electronic device for a long period of time and then a gray gradation image is displayed.

FIG. 14C is a drawing illustrating a captured image generated by an image capture device when an image illustrated in FIG. 11C is displayed on an electronic device for a long period of time and then a gray gradation image is displayed.

FIG. 15 illustrates luminance of each of captured images illustrated in FIGS. 14A, 14B, and 14C.

FIG. 16 is a block diagram of a deterioration optical compensator, according to an embodiment of the present disclosure.

FIG. 17 is a block diagram of a driving controller, according to an embodiment of the present disclosure.

FIG. 18 is a block diagram of a driving controller, according to an embodiment of the present disclosure.

FIG. 19 is a block diagram of a driving controller, according to an embodiment of the present disclosure.

FIG. 20 is a block diagram of a driving controller, according to an embodiment of the present disclosure.

FIG. 21 is a diagram illustrating an optical compensation system, according to an embodiment of the present disclosure.

FIG. 22 is a block diagram illustrating a driving controller, according to an embodiment of the present disclosure.

### DETAILED DESCRIPTION

In the specification, the expression that a first component (or region, layer, part, or the like) is “on”, “connected with”, or “coupled with” a second component means that the first component is directly on, connected with, or coupled with the second component or means that a third component is interposed therebetween.

The same sign refers to the same element. In some aspects, in drawings, the thickness, ratio, and dimension of components are exaggerated for effectiveness of description of technical contents. The term “and/or” includes one or more combinations of the associated listed items.

Although the terms “first”, “second”, and the like may be used to describe various components, the components should not be construed as being limited by the terms. The terms are used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

The terms “under”, “beneath”, “on”, “above”, and the like are used to describe a relationship between components illustrated in a drawing. The terms are relative and are described with reference to a direction indicated in the drawing.

The term “substantially,” as used herein, means approximately or actually. The term “substantially equal” means approximately or actually equal. The term “substantially the same” means approximately or actually the same. The term “substantially perpendicular” means approximately or actually perpendicular. The term “substantially parallel” means approximately or actually parallel.

It will be understood that the terms “include”, “comprise”, “have”, and the like specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Terms such as, for example, terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

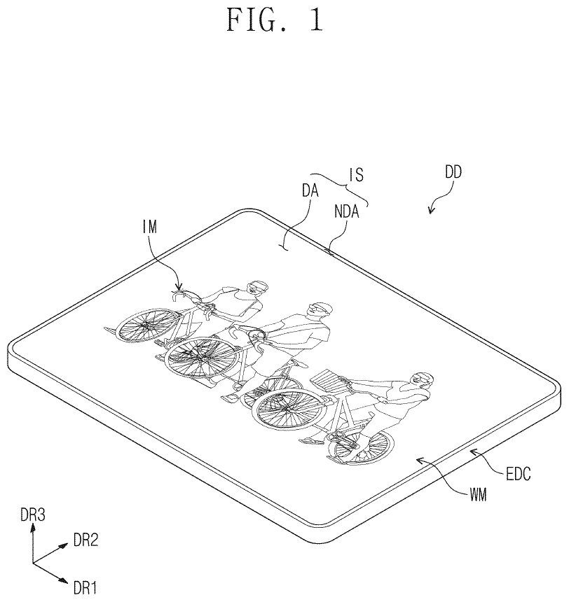

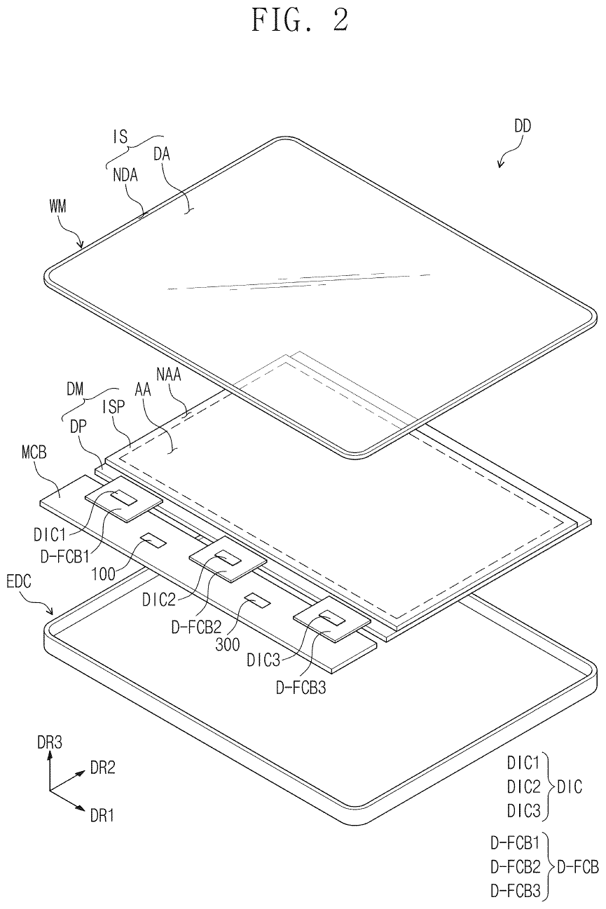

FIG. 1 is a perspective view of an electronic device DD, according to an embodiment of the present disclosure. FIG. 2 is an exploded perspective view of the electronic device DD, according to an embodiment of the present disclosure.

Referring to FIGS. 1 and 2, the electronic device DD may be a device activated based on an electrical signal. The electronic device DD according to an embodiment of the present disclosure may be a small and medium-sized electronic device, such as, for example, a mobile phone, a tablet PC, a notebook computer, a vehicle navigation system, or a game console, as well as a large-sized electronic device, such as, for example, a television or a monitor. The above examples are provided only as examples, and the electronic device DD may be applied to any other display device(s) without departing from the concept of the present disclosure. The electronic device DD has a rectangular shape with a long side in the first direction DR1 and a short side in the second direction DR2 intersecting the first direction DR1. However, the shape of the electronic device DD is not limited thereto. For example, the electronic device DD may be implemented in various shapes. The electronic device DD may display an image IM on a display surface IS parallel to each of the first direction DR1 and the second direction DR2, such that the image is displayed in and faces a third direction DR3.

In an embodiment, a front surface (or an upper/top surface) and a rear surface (or a lower/bottom surface) of each member are defined based on a direction in which the image IM is displayed. The front surface may be opposite to the rear surface in the third direction DR3, and a normal direction of each of the front surface and the rear surface may be parallel to the third direction DR3.

A separation distance between the front surface and the rear surface in the third direction DR3 may correspond to a thickness of the electronic device DD in the third direction DR3. Directions that the first, second, and third directions DR1, DR2, and DR3 indicate may be relative concepts and may be changed to different directions.

The electronic device DD may sense an external input applied from the outside. The external input may include various types of inputs provided from the outside of the electronic device DD. The electronic device DD according to an embodiment of the present disclosure may sense an external input of a user, which is applied from the outside. The external input of the user may be one of various types of external inputs, such as, for example, a part of his/her body, light, heat, his/her gaze, and pressure, or a combination thereof. In some aspects, the electronic device DD may sense the external input of the user applied to a side surface or a rear surface of the electronic device DD based on a structure of the electronic device DD and is not limited to an embodiment. As an example of the present disclosure, an external input may include an input entered through an input device (e.g., a stylus pen, an active pen, a touch pen, an electronic pen, or an E-pen).

The display surface IS of the electronic device DD may be divided into a display area DA and a non-display area NDA. The display area DA may be an area in which the image IM is displayed. A user perceives (or views) the image IM through the display area DA. In an embodiment, the display area DA is illustrated in the shape of a quadrangle whose vertexes are rounded. However, this is illustrated as an example. The display area DA may have various shapes, not limited to an embodiment.

The non-display area NDA is adjacent to the display area DA. The non-display area NDA may have a given color. The non-display area NDA may surround the display area DA. Accordingly, a shape of the display area DA may be defined substantially by the non-display area NDA. However, this is illustrated as an example. The non-display area NDA may be positioned to be adjacent to a single side of the display area DA or may be omitted. The electronic device DD according to an embodiment of the present disclosure may include various embodiments and is not limited to an embodiment.

As illustrated in FIG. 2, the electronic device DD may include a display module DM and a window WM disposed on the display module DM. The display module DM may include a display panel DP and an input sensing layer ISP.

According to an embodiment of the present disclosure, the display panel DP may include a light emitting display panel. For example, the display panel DP may be an organic light emitting display panel, an inorganic light emitting display panel, or a quantum dot light emitting display panel. A light emitting layer of the organic light emitting display panel may include an organic luminescent material. A light emitting layer of the inorganic light emitting display panel may include an inorganic luminescent material. A light emitting layer of the quantum dot light emitting display panel may include a quantum dot, a quantum rod, or the like. Hereinafter, in an embodiment, the description will be given under the condition that the display panel DP is an organic light emitting display panel.

The display panel DP may output the image IM, and the image IM thus output may be displayed through the display surface IS.

The input sensing layer ISP may be disposed on the display panel DP to sense an external input. The input sensing layer ISP may be directly disposed on the display panel DP. According to an embodiment of the present disclosure, the input sensing layer ISP may be formed on the display panel DP by a subsequent process. That is, when the input sensing layer ISP is directly disposed on the display panel DP, an inner adhesive film (not illustrated) is not interposed between the input sensing layer ISP and the display panel DP. However, the inner adhesive film may be interposed between the input sensing layer ISP and the display panel DP. In this case, the input sensing layer ISP is not manufactured together with the display panel DP through the subsequent processes. That is, the input sensing layer ISP may be manufactured through a process separate from a process of manufacturing the display panel DP and may then be fixed on an upper surface of the display panel DP by the inner adhesive film.

The window WM may be formed of a transparent material capable of outputting the image IM. For example, the window WM may be formed of glass, sapphire, plastic, or the like. It is illustrated that the window WM is implemented with a single layer. However, embodiments of the present disclosure are not limited thereto. For example, the window WM may include a plurality of layers.

In some embodiments, although not illustrated, the non-display area NDA of the electronic device DD described herein may correspond to an area that is defined by printing a material including a given color on one area of the window WM. As an example of the present disclosure, the window WM may include a light blocking pattern for defining the non-display area NDA. The light blocking pattern that is a colored organic film may be formed, for example, in a coating manner.

The window WM may be coupled to the display module DM through an adhesive film. As an example of the present disclosure, the adhesive film may include an optically clear adhesive (OCA) film. However, the adhesive film is not limited thereto. For example, the adhesive film may include a typical adhesive or sticking agent. For example, the adhesive film may include an optically clear resin (OCR) or a pressure sensitive adhesive (PSA) film.

An anti-reflection layer may be further disposed between the window WM and the display module DM. The anti-reflection layer decreases the reflectivity of external light incident from above the window WM. The anti-reflection layer according to an embodiment of the present disclosure may include a phase retarder and a polarizer.

The display module DM may display the image IM based on an electrical signal and may transmit/receive information about an external input. The display module DM may be defined by an active area AA and an inactive area NAA. The active area AA may be defined as an area through which the image IM provided from the display area DA is output. In some aspects, the active area AA may be defined as an area in which the input sensing layer ISP senses an external input applied from the outside.

The inactive area NAA is adjacent to the active area AA. For example, the inactive area NAA may surround the active area AA. However, this is illustrated by way of example. The inactive area NAA may be defined in various shapes, not limited to an embodiment. According to an embodiment, the active area AA of the display module DM may correspond to at least part of the display area DA.

The electronic device DD may further include a main circuit board MCB, flexible circuit films D-FCB, driver chips DIC, a driving controller 100, and a voltage generator 300. The main circuit board MCB may be connected to the flexible circuit films D-FCB and be electrically connected to the display panel DP. The flexible circuit films D-FCB are connected to the display panel DP and electrically connect the display panel DP to the main circuit board MCB. The main circuit board MCB may include a plurality of driving elements. The plurality of driving elements may include a circuit unit for driving the display panel DP. The driver chips DIC may be mounted on the flexible circuit films D-FCB, respectively.

As an example of the present disclosure, the flexible circuit films D-FCB may include a first flexible circuit film D-FCB1, a second flexible circuit film D-FCB2, and a third flexible circuit film D-FCB3. The driver chips DIC may include a first driver chip DIC1, a second driver chip DIC2, and a third driver chip DIC3. The first to third flexible circuit films D-FCB1, D-FCB2, and D-FCB3 may be positioned spaced from one another in the first direction DR1 and may be connected with the display panel DP and electrically connect the display panel DP and the main circuit board MCB. The first driver chip DIC1 may be mounted on the first flexible circuit film D-FCB1. The second driver chip DIC2 may be mounted on the second flexible circuit film D-FCB2. The third driver chip DIC3 may be mounted on the third flexible circuit film D-FCB3. However, an embodiment of embodiments of the present disclosure are not limited thereto. For example, the display panel DP may be electrically connected with the main circuit board MCB through one flexible circuit film, and a single driver chip may be mounted on the one flexible circuit film. In some aspects, the display panel DP may be electrically connected with the main circuit board MCB through four or more flexible circuit films, and driver chips may be respectively mounted on the flexible circuit films.

A structure in which the first to third driver chips DIC1, DIC2, and DIC3 are respectively mounted on the first to third flexible circuit films D-FCB1, D-FCB2, and D-FCB3 is illustrated in FIG. 2, but embodiments of the present disclosure are not limited thereto. For example, the first to third driver chips DIC1, DIC2, and DIC3 may be directly mounted on the display panel DP. In this case, a portion of the display panel DP, on which the first to third driver chips DIC1, DIC2, and DIC3 are mounted, may be bent such that the first to third driver chips DIC1, DIC2, and DIC3 are disposed on a rear surface of the display module DM. In some aspects, the first to third driver chips DIC1, DIC2, and DIC3 may be directly mounted on the main circuit board MCB.

The input sensing layer ISP may be electrically connected with the main circuit board MCB through the flexible circuit films D-FCB. However, an embodiment of embodiments of the present disclosure are not limited thereto. That is, the display module DM may additionally include a separate flexible circuit film for electrically connecting the input sensing layer ISP and the main circuit board MCB.

In an embodiment, the driving controller 100 and the voltage generator 300 may be disposed on the main circuit board MCB. The driving controller 100 and the voltage generator 300 may be electrically connected to the display panel DP through the main circuit board MCB and the flexible circuit films D-FCB.

The electronic device DD further includes an external case EDC for accommodating the display module DM. The outer case EDC may be coupled with the window WM to define the exterior of the electronic device DD. The outer case EDC may absorb external shocks and may prevent a foreign material/moisture or the like from being infiltrated into the display module DM such that components accommodated in the outer case EDC are protected. In some aspects, as an example of the present disclosure, the outer case EDC may be provided in the form of a combination of a plurality of accommodating members.

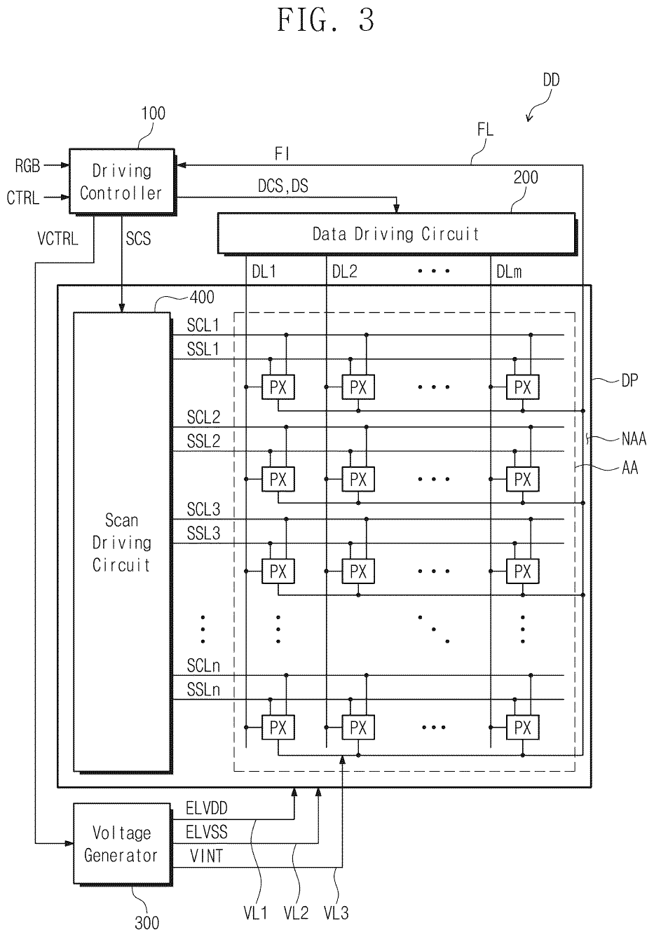

FIG. 3 is a block diagram of an electronic device, according to an embodiment of the present disclosure.

Referring to FIG. 3, the electronic device DD includes a driving controller 100, a data driving circuit 200, a voltage generator 300, a scan driving circuit 400, and a display panel DP. The driving controller 100, the data driving circuit 200, and the scan driving circuit 400 may be referred to as a “driving circuit” for providing a data signal to pixels PX of the display panel DP.

The driving controller 100 receives an input image signal RGB and a control signal CTRL. The driving controller 100 converts the input image signal RGB into an image data signal DS and outputs the image data signal DS. The driving controller 100 outputs a scan control signal SCS and a data control signal DCS. In an embodiment, the driving controller 100 may output a voltage control signal VCTRL for controlling the voltage generator 300.

The data driving circuit 200 receives the data control signal DCS and the image data signal DS from the driving controller 100. The data driving circuit 200 converts the image data signal DS into data signals and then outputs the data signals to a plurality of data lines DL1 to DLm to be described later. The data signals refer to analog voltages corresponding to grayscale values of the image data signal DS. The data driving circuit 200 may be disposed in the driver chips DIC illustrated in FIG. 2.

The display panel DP includes first scan lines SCL1 to SCLn, second scan lines SSL1 to SSLn, the data lines DL1 to DLm, and pixels PX.

The display panel DP may be divided into the active area AA and the inactive area NAA. The display panel DP includes the pixels PX, the first scan lines SCL1 to SCLn, the second scan lines SSL1 to SSLn, and the data lines DL1 to DLm. The pixels PX may be positioned in the active area AA. The scan driving circuit 400 may be positioned in the inactive area NAA.

The plurality of pixels PX are electrically connected to the first scan lines SCL1 to SCLn, the second scan lines SSL1 to SSLn, and the data lines DL1 to DLm. For example, the first row of pixels may be connected to the scan lines SCL1 and SSL1. Moreover, the second row of pixels may be connected to the scan lines SCL2 and SSL2.

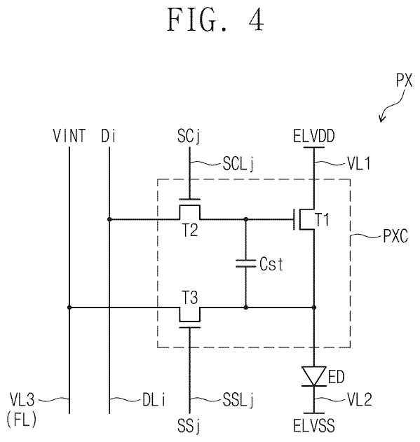

Each of the plurality of pixels PX includes a light emitting element ED (see FIG. 4) and a pixel circuit PXC (see FIG. 4) for controlling the light emission of the light emitting element ED. The pixel circuit PXC may include a plurality of transistors and a capacitor. The scan driving circuit 400 may include transistors formed through the same process as the pixel circuit PX C. In an embodiment, the light emitting element ED may be an organic light emitting diode. However, embodiments of the present disclosure are not limited thereto.

Each of the plurality of pixels PX receives a first driving voltage ELVDD, a second driving voltage ELVSS, and an initialization voltage VINT.

The scan driving circuit 400 receives the scan control signal SCS from the driving controller 100. In response to the scan control signal SCS, the scan driving circuit 400 may output first scan signals to the first scan lines SCL1 to SCLn and may output second scan signals to the second scan lines SSL1 to SSLn.

In an embodiment, the scan driving circuit 400 may be placed in the inactive area NAA adjacent to the first side of the active area AA. The first scan lines SCL1 to SCLn and the second scan lines SSL1 to SSLn extend in the first direction DR1 from the scan driving circuit 400.

In an embodiment, the scan driving circuit 400 may be disposed on each of a first side and a second side of the active area AA. For example, the scan driving circuit disposed on the first side of the active area AA may provide the first scan signals to the first scan lines SCL1 to SCLn. The scan driving circuit disposed on the second side of the active area AA may provide the second scan signals to the second scan lines SSL1 to SSLn.

The voltage generator 300 generates voltages for operating the display panel DP. In an embodiment, the voltage generator 300 generates a first driving voltage ELVDD, a second driving voltage ELVSS, and an initialization voltage VINT, which support operations of the display panel DP. The first driving voltage ELVDD, the second driving voltage ELVSS and the initialization voltage VINT may be provided to the display panel DP through a first voltage line VL1, a second voltage line VL2, and a third voltage line VL3.

As well as the first driving voltage ELVDD, the second driving voltage ELVSS, and the initialization voltage VINT, the voltage generator 300 may further generate various voltages for operations of the display panel DP, the driving controller 100, the data driving circuit 200, and the scan driving circuit 400.

In an embodiment, the driving controller 100 may output the voltage control signal VCTRL for setting a voltage level of a first driving voltage based on the input image signal RGB.

In an embodiment, the driving controller 100 may sense the deterioration of the pixels PX based on a feedback current signal FI received from the display panel DP through a feedback line FL. The configuration and operation of the driving controller 100 will be described in detail later.

FIG. 4 is an equivalent circuit diagram of a pixel, according to an embodiment of the present disclosure.

FIG. 4 illustrates an equivalent circuit diagram of a pixel PX connected to an i-th data line DLi among the data lines DL1 to DLm, a j-th first scan line SCLj among the first scan lines SCL1 to SCLn, and a j-th second scan line SSLj among the second scan lines SSL1 to SSLn, which are illustrated in FIG. 1.

Each of the plurality of pixels PX illustrated in FIG. 3 may have the same circuit configuration as the equivalent circuit diagram of the pixel PX illustrated in FIG. 4. In an embodiment, the pixel PX includes the at least one light emitting element ED and the pixel circuit PX C.

The pixel circuit PXC may include at least one transistor, which is electrically connected to the light emitting element ED and which is used to provide a current corresponding to the data signal Di delivered from the data line DLi to the light emitting element ED. In an embodiment, the pixel circuit PX C of the pixel PX includes a first transistor T1, a second transistor T2, a third transistor T3, and a capacitor Cst. Each of the first to third transistors T1 to T3 is an N-type transistor by using an oxide semiconductor as a semiconductor layer. However, embodiments of the present disclosure are not limited thereto. For example, each of the first to third transistors T1 to T3 may be a P-type transistor having a low-temperature polycrystalline silicon (LTPS) semiconductor layer. In an embodiment, at least one of the first to third transistors T1 to T3 may be an N-type transistor and the others of the first to third transistors T1 to T3 may be P-type transistors. Moreover, the circuit configuration of a pixel according to an embodiment of the present disclosure is not limited to an embodiment of FIG. 4. The pixel circuit PX C illustrated in FIG. 3 is an example. For example, the configuration of the pixel circuit PX C may be modified and implemented.

Referring to FIG. 3, the first scan line SCLj may deliver the first scan signal SCj. The second scan line SSLj may deliver the second scan signal SSj. The data line DLi delivers a data signal Di. The data signal Di may have a voltage level corresponding to the input image signal RGB input to the electronic device DD (see FIG. 1).

The first driving voltage ELVDD and the initialization voltage VINT may be delivered to the pixel circuit PX C through the first voltage line VL1 and the third voltage line VL3, respectively. The second driving voltage ELVSS may be delivered to a cathode (or a second terminal) of the light emitting element ED through the second voltage line VL2.

The first transistor T1 includes a first electrode connected to the first voltage line VL1, a second electrode electrically connected to an anode (or a first terminal) of the light emitting element ED, and a gate electrode connected to one end of the capacitor Cst. The first transistor T1 may supply a driving current to the light emitting element ED in response to the data signal Di delivered through the data line DLi based on a switching operation of the second transistor T2.

The second transistor T2 includes a first electrode connected to the data line DLi, a second electrode connected to the gate electrode of the first transistor T1, and a gate electrode connected to the first scan line SCLj. The second transistor T2 may be turned on in response to the first scan signal SCj received through the first scan line SCLj such that the second transistor T2 delivers the data signal Di delivered through the data line DLi to the gate electrode of the first transistor T1.

The third transistor T3 includes a first electrode connected to the third voltage line VL3, a second electrode connected to the anode of the light emitting element ED, and a gate electrode connected to the second scan line SSLj. The third transistor T3 may be turned on in response to the second scan signal SSj received through the second scan line SSLj such that the third transistor T3 delivers the initialization voltage VINT to the anode of the light emitting element ED.

As described herein, one end of the capacitor Cst is connected to the gate electrode of the first transistor T1, and the other end of the capacitor Cst is connected to the second electrode of the first transistor T1. The structure of the pixel PX according to an embodiment is not limited to the structure illustrated in FIG. 4. The number of transistors included in the pixel PX, the number of capacitors, and the connection relationship may be modified in various manners.

The pixel PX may operate in an emission mode and a current sensing mode. In an example in which the third transistor T3 is turned on in the emission mode, the initialization voltage VINT from the third voltage line VL3 may be delivered to the anode of the light emitting element ED.

When the third transistor T3 is turned on in the current sensing mode, the current of the anode of the light emitting element ED corresponding to the data signal Di may be delivered to the third voltage line VL3. In an embodiment, the third voltage line VL3 may be the feedback line FL.

In an embodiment, the third voltage line VL3 and the feedback line FL may be different wires from each other.

In an embodiment, the feedback line FL may be directly connected to the anode of the light emitting element ED. In other words, the current (i.e., the feedback current FI (see FIG. 3) of the anode of the light emitting element ED may be directly delivered to the driving controller 100 (see FIG. 3) through the feedback line FL.

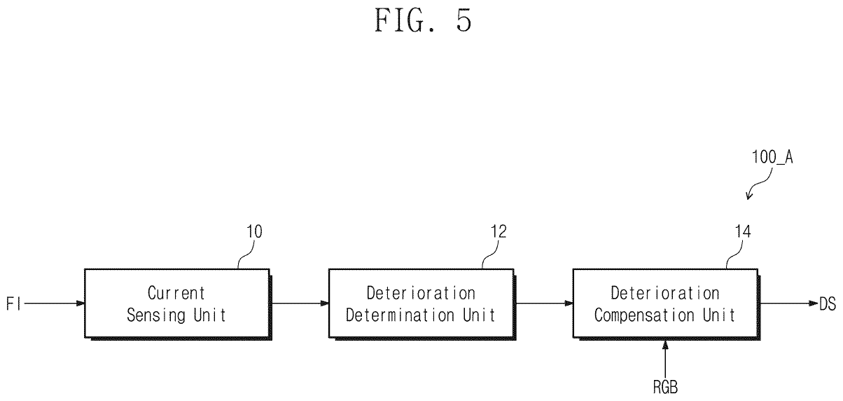

FIG. 5 is a block diagram illustrating a driving controller 100_A.

The driving controller 100_A illustrated in FIG. 5 is illustrated as including configurations related to a deterioration compensation operation among the configurations or functions of the driving controller 100 illustrated in FIG. 3, but embodiments of the present disclosure are not limited thereto.

Referring to FIGS. 4 and 5, the driving controller 100_A includes a current sensing unit 10, a deterioration determination unit 12, and a deterioration compensation unit 14. In an embodiment, each of the current sensing unit 10, the deterioration determination unit 12, and the deterioration compensation unit 14 may include physical components. In an embodiment, each of the current sensing unit 10, the deterioration determination unit 12, and the deterioration compensation unit 14 may be a software program or a memory storing the software program.

The current sensing unit 10 senses the feedback current FI from the pixel PX. The deterioration determination unit 12 determines the deterioration characteristics of the pixels PX based on the sensed feedback current FI. The deterioration compensation unit 14 performs deterioration compensation based on the deterioration characteristics of the pixels PX.

For example, the deterioration compensation unit 14 may output the image data signal DS by adding a compensation value corresponding to the deterioration characteristics of the pixels PX to the input image signal RGB.

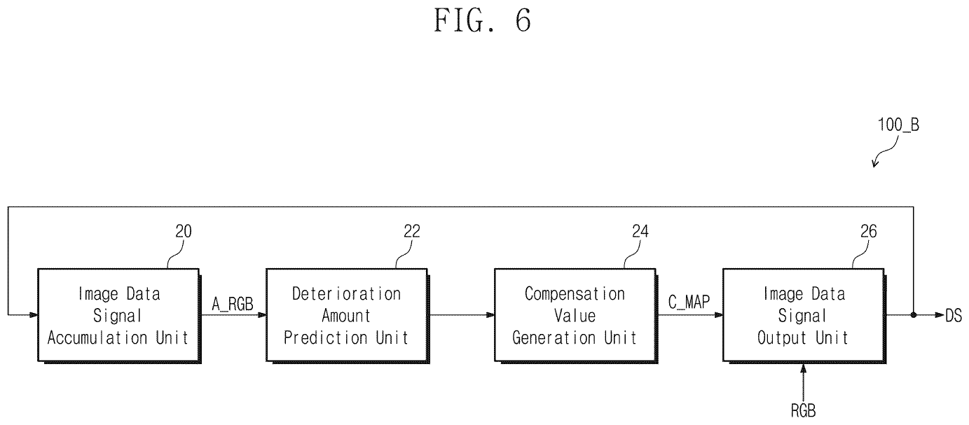

FIG. 6 is a block diagram illustrating a driving controller 100_B.

The driving controller 100_B illustrated in FIG. 6 is illustrated as including configurations related to a deterioration compensation operation among the configurations or functions of the driving controller 100 illustrated in FIG. 3, but embodiments of the present disclosure are not limited thereto.

Referring to FIGS. 4 and 6, the driving controller 100_B includes an image data signal accumulation unit 20, a deterioration amount prediction unit 22, a compensation value generation unit 24, and an image data signal output unit 26.

The image data signal accumulation unit 20 accumulates the image data signal DS and outputs an accumulation image signal A_RGB.

The deterioration amount prediction unit 22 predicts the deterioration amount of each of the pixels PX based on the accumulation image signal A_RGB.

The compensation value generation unit 24 generates a compensation value corresponding to each of the pixels PX based on the predicted deterioration amount of each of the pixels PX. That is, for example, the compensation value generation unit 24 may generate compensation values respectively corresponding to the pixels PX, based on predicted deterioration amounts respectively corresponding to the pixels PX. In an embodiment, the compensation value generation unit 24 may generate a compensation map C_MAP by using the generated compensation values. The compensation map C_MAP may include information about a compensation value corresponding to each grayscale level of pixels.

The image data signal output unit 26 performs deterioration compensation based on the deterioration characteristics of each of the pixels PX. For example, the image data signal output unit 26 may output the image data signal DS by adding a compensation value corresponding to each of the pixels PX to the input image signal RGB with reference to the compensation map C_MAP.

The driving controller 100_A illustrated in FIG. 5 has difficulty in accurately sensing the degree of deterioration of each of the pixels PX. Because the driving controller 100_B illustrated in FIG. 6 predicts the deterioration of each of the pixels PX based on the input image signal RGB, it is difficult to accurately predict the actual deterioration degree of the light emitting element ED (see FIG. 4).

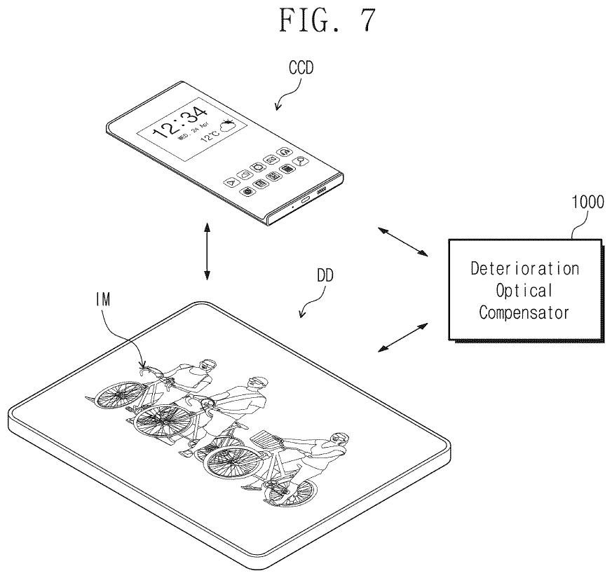

FIG. 7 is a diagram illustrating an optical compensation system, according to an embodiment of the present disclosure.

Referring to FIG. 7, an optical compensation system includes the electronic device DD, an image capture device CCD, and a deterioration optical compensator 1000.

The image capture device CCD is a device that includes a camera for capturing the image IM displayed on the electronic device DD. FIG. 7 illustrates a smart phone as an example of the image capture device CCD, but embodiments of the present disclosure are not limited thereto. The image capture device CCD may include various devices for capturing an image. The image capture device CCD may provide the captured image to the deterioration optical compensator 1000. For example, the image capture device CCD may provide a captured image signal C_IMG, and the captured image signal C_IMG may be a data signal (i.e., image signal) representative of the image IMG1 as captured by the image capture device CCD.

The deterioration optical compensator 1000 receives the captured image from the image capture device CCD. The deterioration optical compensator 1000 receives an accumulation image signal (e.g., an accumulation image signal A_RGB described herein) and a compensation map (e.g., a compensation map C_MAP described herein) from the electronic device DD.

The deterioration optical compensator 1000 generates a final compensation map (e.g., a compensation map F_MAP described herein) based on the captured image from the image capture device CCD and the accumulation image signal and the compensation map from the electronic device DD. The deterioration optical compensator 1000 provides the final map to the electronic device DD.

The electronic device DD performs deterioration compensation based on the final compensation map provided from the deterioration optical compensator 1000. For example, the electronic device DD may output the image data signal DS, which is obtained by compensating for the input image signal RGB with reference to the final compensation map.

In an embodiment, the deterioration optical compensator 1000 may be an independent test device for compensating for the deterioration of the electronic device DD, or a memory storing a test program.

Although FIG. 7 illustrates that the deterioration optical compensator 1000 is an independent device, embodiments of the present disclosure are not limited thereto. In an embodiment, the electronic device DD and the deterioration optical compensator 1000 may be implemented as a single device. In an embodiment, the image capture device CCD and the deterioration optical compensator 1000 may be implemented as one device.

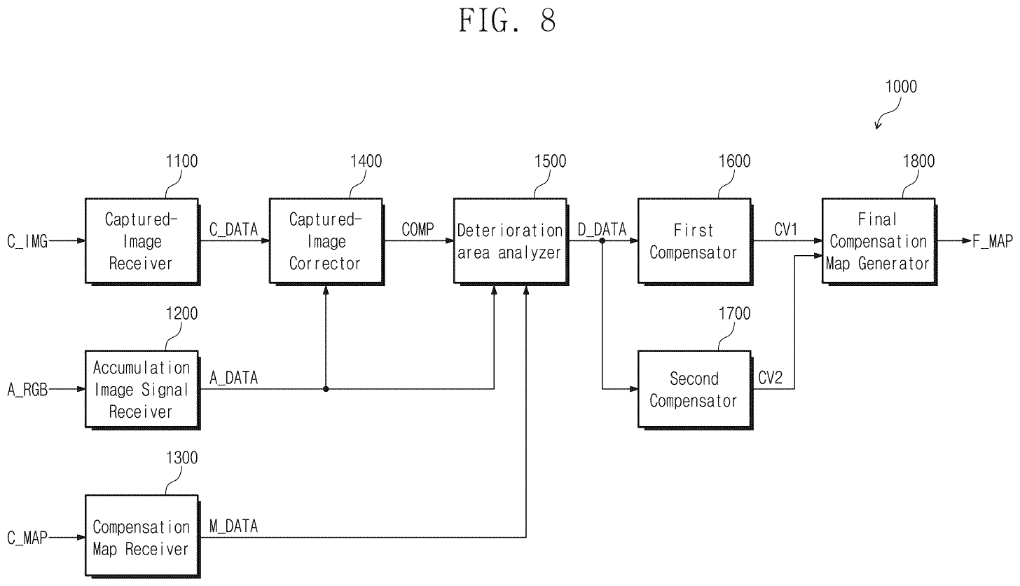

FIG. 8 is a block diagram of the deterioration optical compensator 1000, according to an embodiment of the present disclosure.

Referring to FIGS. 7 and 8, the deterioration optical compensator 1000 includes a captured-image receiver 1100, an accumulation image signal receiver 1200, a compensation map receiver 1300, a captured-image corrector 1400, a deterioration area analyzer 1500, a first compensator 1600, a second compensator 1700, and a final compensation map generator 1800.

The captured-image receiver 1100 receives a captured image signal C_IMG from the image capture device CCD and outputs an imaging data signal C_DATA.

The accumulation image signal receiver 1200 receives the accumulation image signal A_RGB from the electronic device DD and outputs an accumulation data signal A_DATA. In an embodiment, the accumulation image signal A_RGB may be a signal generated by the image data signal accumulation unit 20 in the driving controller 100_B illustrated in FIG. 6. In other words, the accumulation image signal A_RGB may be a signal obtained by accumulating the data control signal DCS.

The compensation map receiver 1300 receives the compensation map C_MAP from the electronic device DD and outputs map data M_DATA. In an embodiment, the compensation map C_MAP may include compensation values predetermined in the electronic device DD. In an embodiment, the compensation map C_MAP may be a compensation map generated by the compensation value generation unit 24 in the driving controller 100_B illustrated in FIG. 6.

The captured-image corrector 1400 corrects the imaging data signal C_DATA with reference to the accumulation data signal A_DATA and outputs a correction data signal COM P.

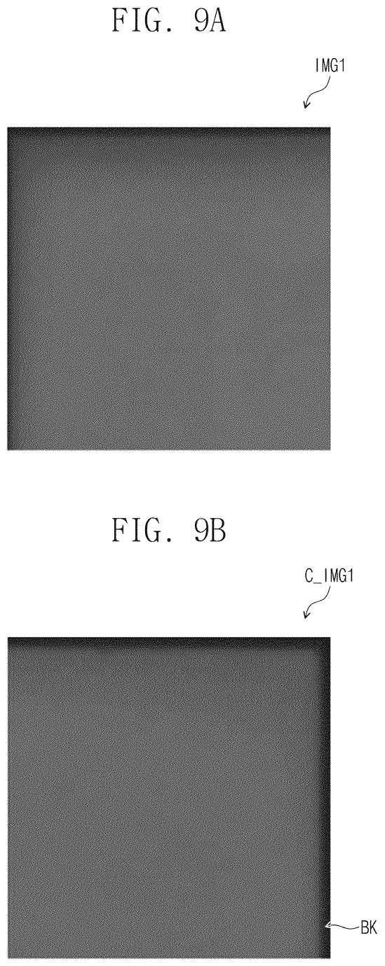

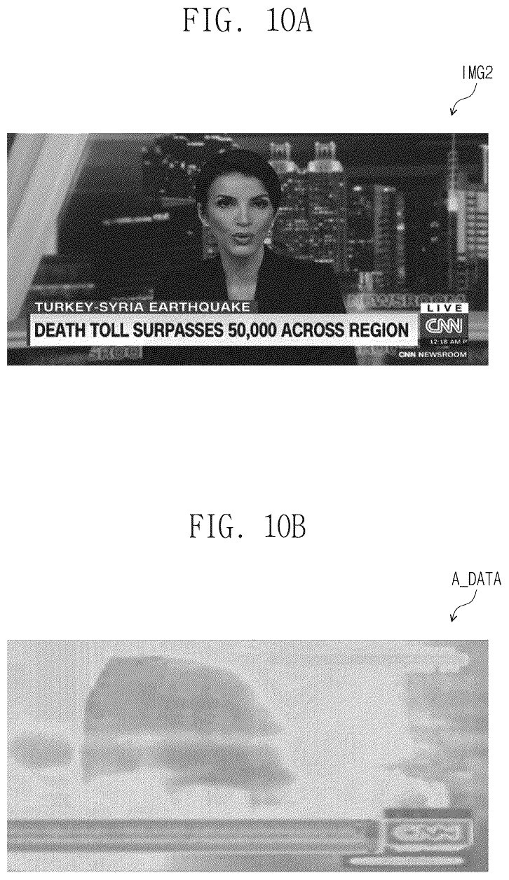

FIG. 9A is a drawing illustrating an image IMG1 displayed on the electronic device DD. FIG. 9B is a drawing illustrating a captured image C_IMG1 by the image capture device CCD.

Referring to FIGS. 7, 8, 9A, and 9B, the image capture device CCD captures the image IMG1 displayed on the electronic device DD. Due to various causes, there is an error between the captured image C_IMG1 generated by the image capture device CCD and the image IMG1 displayed on the electronic device DD. For example, the captured image signal C_IMG may not match the image displayed on the electronic device DD due to external factors such as, for example, the resolution of the image capture device CCD, the distance and/or angle between the image capture device CCD and the electronic device DD, and the shaking of the image capture device CCD. In the example illustrated in FIG. 9B, the captured image C_IMG1 includes a black area BK unlike the image IMG1.

The accumulation data signal A_DATA may be obtained by accumulating data control signal DCS provided to the pixels PX (see FIG. 3), and thus the deterioration degree of the pixels PX may be predicted based on the accumulation data signal A_DATA.

The captured-image corrector 1400 may determine whether each of the pixels PX (see FIG. 3) is degraded, with reference to the accumulation data signal A_DATA. For example, the captured-image corrector 1400 may determine respective degradation amounts of the pixels PX (see FIG. 3), with reference to the accumulation data signal A_DATA. The captured-image corrector 1400 may determine whether each of the pixels PX (see FIG. 3) is degraded, based on the imaging data signal C_DATA. For example, the captured-image corrector 1400 may determine whether any of the pixels PX (see FIG. 3) are degraded, based on the imaging data signal C_DATA. The captured-image corrector 1400 compares first deterioration pixels, which are determined based on the accumulation data signal A_DATA, with second deterioration pixels determined based on the imaging data signal C_DATA and corrects the imaging data signal C_DATA based on the comparison result. The captured-image corrector 1400 outputs the correction data signal COM P corresponding to the imaging data signal C_DATA.

The deterioration area analyzer 1500 determines the deterioration area of the display panel DP (see FIG. 3) based on the correction data signal COM P, the accumulation data signal A_DATA, and the compensation map C_MAP.

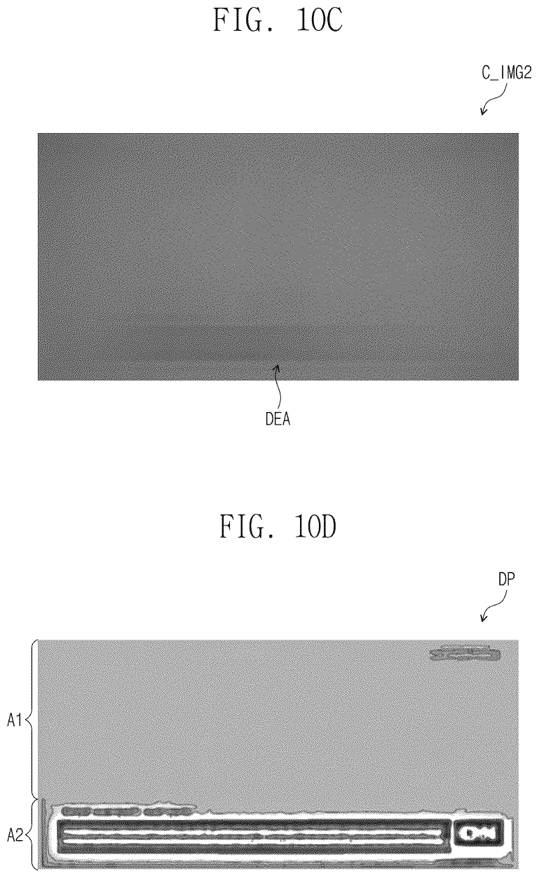

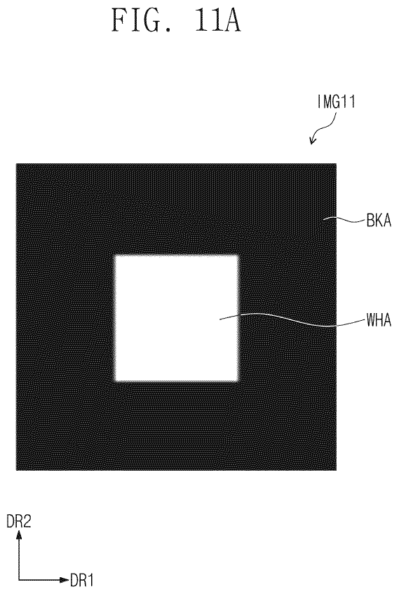

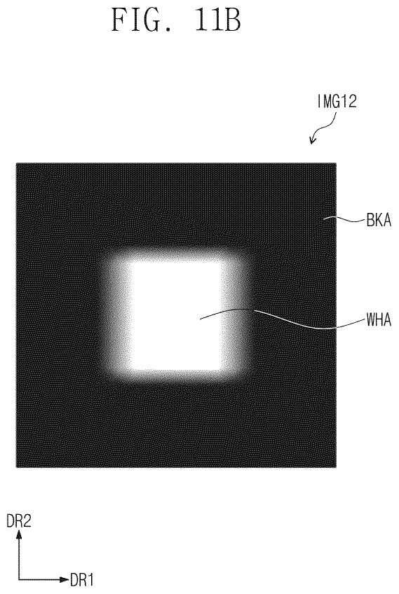

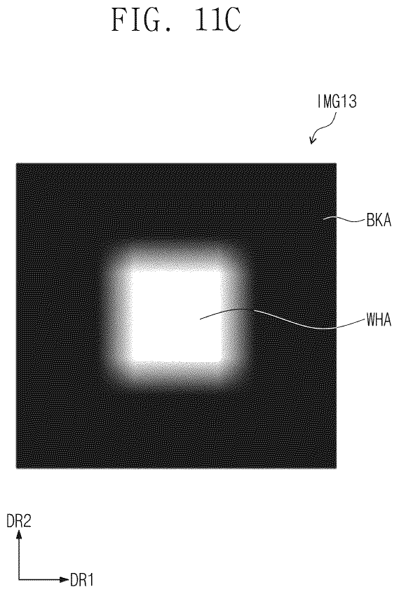

FIG. 10A is a drawing illustrating an image IMG2 displayed on the electronic device DD. FIG. 10B is a drawing illustrating the accumulation data signal A_DATA of the electronic device DD as an image. FIG. 10C is a drawing illustrating a captured image C_IMG2 from the image capture device CCD when the image IMG2 illustrated in FIG. 10A is displayed on an electronic device for a long period of time and then a gray gradation image is displayed. FIG. 10D is a diagram for describing a method for determining a deterioration area.

Referring to FIGS. 7, 8, 10A, and 10B, when the image IMG2 is displayed on the electronic device DD for a long period of time, the deterioration value of the accumulation data signal A_DATA corresponding to a specific area (e.g., a portion where a subtitle is displayed) may increase.

When the image IMG2 illustrated in FIG. 10A is displayed for a long period of time and then a gray gradation image is displayed, as illustrated in FIG. 10C, a partial area DEA of a captured image C_IMG2 includes a darker gray gradation image.

The deterioration area analyzer 1500 may determine the deterioration degree of each of the pixels PX (see FIG. 3) of the display panel DP (see FIG. 3) based on the correction data signal COM P, the accumulation data signal A_DATA, and the compensation map C_MAP.

As illustrated in FIG. 10D, the deterioration area analyzer 1500 may divide the display panel DP into a normal area A1 and a deterioration area A2 based on the deterioration degree of each of the pixels PX. The normal area A1 may be an area with little deterioration, and the deterioration area A2 may be an area with a lot of deterioration.

In an example in which the correction data signal COM P corresponds to the normal area A1, the deterioration area analyzer 1500 outputs the data signal D_DATA to the first compensator 1600. In an example in which the correction data signal COM P corresponds to the deterioration area A2, the deterioration area analyzer 1500 outputs the data signal D_DATA to the second compensator 1700. In an embodiment, the data signal D_DATA may be the same as the correction data signal COMP.

The first compensator 1600 outputs a first compensation value CV1 for compensating for the data signal D_DATA corresponding to the normal area A1. In an embodiment, the first compensator 1600 may output the first compensation value CV1 for compensating for the data signal D_DATA in units of blocks corresponding to the plurality of pixels PX. For example, one block may correspond to 8×8 of the pixels PX. The first compensator 1600 may divide the normal area A1 into a plurality of blocks and may output the first compensation value CV1 corresponding to each of the blocks. Accordingly, for example, the first compensator 1600 may generate the first compensation value CV1 in units of blocks of the normal area A1 based on the data signal D_DATA.

The second compensator 1700 outputs a second compensation value CV2 for compensating for the data signal D_DATA corresponding to the deterioration area A2. In an embodiment, the second compensator 1700 may output the second compensation value CV2 for compensating for the data signal D_DATA corresponding to each of the pixels PX. That is, the second compensation value CV2 may correspond to each of the pixels PX. Accordingly, for example, the second compensator 1700 may generate the second compensation value CV2 in units of pixels of the deterioration area A2 based on the data signal D_DATA.

The final compensation map generator 1800 outputs a final compensation map F_MAP by combining the first compensation value CV1 corresponding to the normal area A1 and the second compensation value CV2 corresponding to the deterioration area A2. The final compensation map F_MAP may include a compensation value corresponding to each of the pixels PX of the display panel DP. The final compensation map F_MAP is provided to the electronic device DD.

The driving controller 100 (see FIG. 3) of the electronic device DD may output the image data signal DS by performing deterioration compensation on the input image signal RGB based on the final compensation map F_MAP. In an embodiment, the final compensation map F_MAP may be implemented as a lookup table.

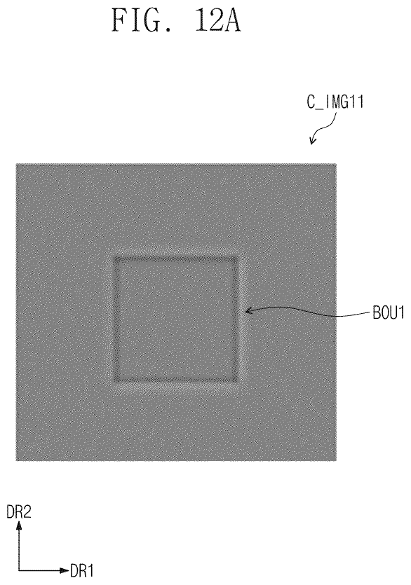

FIGS. 11A, 11B, and 11C are drawings illustrating images IMG11, IMG12, and IMG13 displayed on the electronic device DD, respectively.

Referring to FIGS. 11A, 11B, and 11C, each of the images IMG11, IMG12, and IMG13 includes a black area BKA, in which a black gradation image is displayed, and a white area WHA in which a white gradation image is displayed.

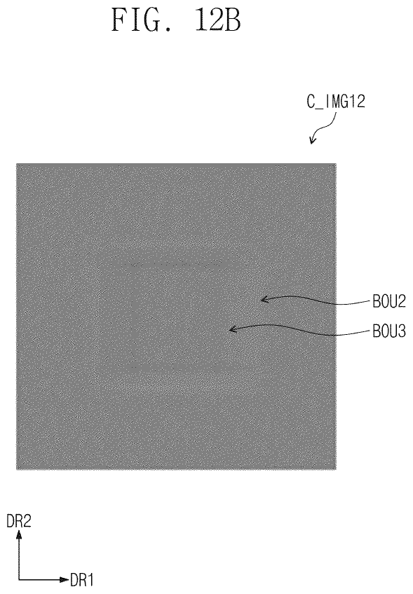

FIGS. 12A, 12B, and 12C are drawings respectively illustrating images C_IMG11, C_IMG12, and C_IMG13 captured by the image capture device CCD when the images IMG11, IMG12, and IMG13 illustrated in FIGS. 11A, 11B, and 11C are displayed on the electronic device DD for a long period of time and then a gray gradation image is displayed.

As illustrated in FIG. 11A, an image including patterns with a great grayscale difference may be displayed on the electronic device DD for a long period of time, and then a gray gradation image may be displayed as illustrated in FIG. 12A. The captured image C_IMG11 generated by the image capture device CCD may include an image having an undesired grayscale at a boundary between the black area BKA, in which the black gradation image is displayed, and the white area WHA where the white gradation image is displayed.

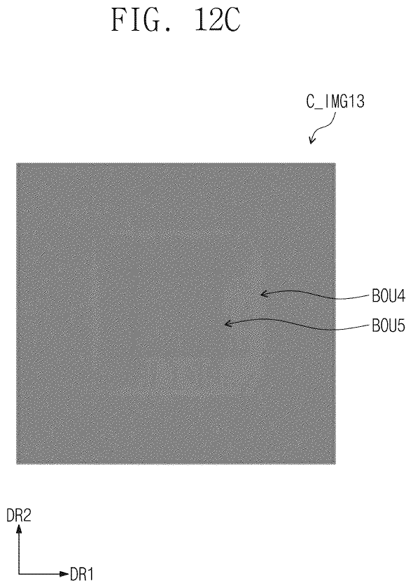

FIG. 13 illustrates the luminance of an image when a gray gradation image is displayed on the electronic device DD after the grayscale image IMG11 illustrated in FIG. 11A is displayed for a long period of time.

In FIG. 13, a first line L1 indicates the luminance of the image displayed on the electronic device DD when the driving controller 100 does not perform any compensation operation. A second line L2 indicates the luminance corresponding to the captured image C_IMG11 illustrated in FIG. 12A when the driving controller 100 performs a deterioration compensation operation as illustrated in FIG. 6.

In FIG. 13, a horizontal axis indicates a location of the pixel PX in the first direction DR1 illustrated in FIG. 11A, and a vertical axis indicates luminance.

Referring to FIGS. 6, 11A, 12A, and 13, in the case where the driving controller 100 does not perform any compensation operation, when the luminance for the target grayscale is set to 100%, the luminance of the white area WHA is lower than the luminance of the black area BKA. The reason is that the pixels PX (see FIG. 3) of the white area WHA are more degraded than the pixels PX of the black area BKA.

When the driving controller 100 performs the deterioration compensation operation as illustrated in FIG. 6, the luminance of the white area WHA is similar to the luminance of the black area BKA. However, deterioration overcompensation may occur at a boundary between the white area WHA and the black area BKA. In other words, near the boundary, the luminance of the black area BKA becomes higher than the luminance (100%) of the gray gradation, and the luminance of the white area WHA becomes lower than the luminance (100%) of the gray gradation.

In this case, as illustrated in FIG. 12A, even when a gray gradation image is displayed on the entire display surface of the electronic device DD, an undesired image pattern may be displayed at a boundary BOU1 between the white area WHA and the black area BKA.

FIG. 11B illustrates that the white area WHA is moved by the driving controller 100. In the example illustrated in FIG. 11B, the white area WHA moves by 16 pixels in the first direction DR1 and by 8 pixels in the second direction DR2 at regular time intervals (e.g., every few tens to several hundred frames).

FIG. 11C illustrates that the white area WHA is moved by the driving controller 100. In the example illustrated in FIG. 11C, the white area WHA moves by 16 pixels in the first direction DR1 and by 16 pixels in the second direction DR2 at regular time intervals (e.g., every few tens to several hundred frames).

The image shift illustrated in FIGS. 11B and 11C is intended to blur the boundary between the white area WHA and the black area BKA.

Referring to the captured images C_IMG12 and C_IMG13 generated by the image capture device CCD when the images IMG11, IMG12, and IMG13 illustrated in FIGS. 11B and 11C are displayed on the electronic device for a long period of time and then a gray gradation image is displayed, an undesired image pattern may be displayed at boundaries BOU2, BOU3, BOU4, and BOU5 between the white area WHA and the black area BKA.

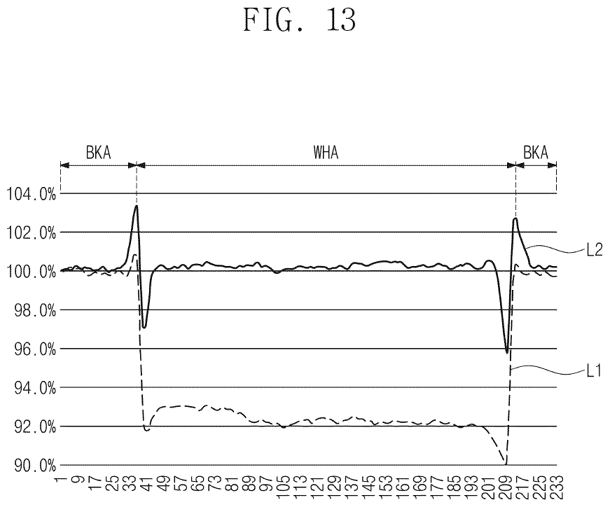

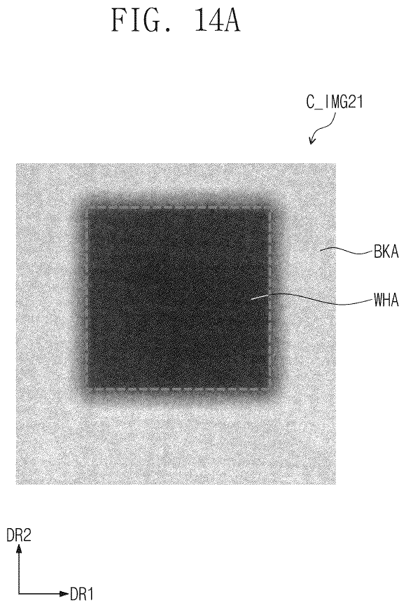

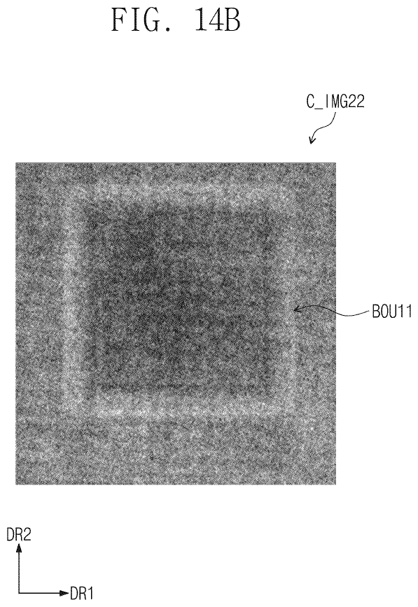

FIG. 14A is a drawing illustrating a captured image C_IMG21 generated by the image capture device CCD when the image IMG13 illustrated in FIG. 11C is displayed on the electronic device DD for a long period of time and then a gray gradation image is displayed. FIG. 14A illustrates the captured image C_IMG21 when the driving controller 100 did not perform any compensation operation while the image IMG13 illustrated in FIG. 11C is displayed on the electronic device DD for a long period of time.

Referring to FIGS. 11C and 14A, even when a data signal corresponding to gray gradation is provided to all the pixels PX of the electronic device DD, the luminance of the white area WHA is lower than the luminance of the black area BKA.

FIG. 14B is a drawing illustrating a captured image C_IMG22 generated by the image capture device CCD when the image IMG13 illustrated in FIG. 11C is displayed on the electronic device DD for a long period of time and then a gray gradation image is displayed. FIG. 14B illustrates the captured image C_IMG22 generated by the image capture device CCD when the driving controller 100 performs the deterioration compensation operation as illustrated in FIG. 6.

Referring to FIGS. 11C and 14B, an undesired image pattern may be displayed at a boundary BOU11 between the white area WHA and the black area BKA.

FIG. 14C is a drawing illustrating a captured image C_IMG23 generated by the image capture device CCD when the image IMG13 illustrated in FIG. 11C is displayed on the electronic device DD for a long period of time and then a gray gradation image is displayed. FIG. 14C illustrates the captured image C_IMG23 generated by the image capture device CCD when the driving controller 100 performs the deterioration compensation operation based on the final compensation map F_MAP generated by the deterioration optical compensator 1000 illustrated in FIG. 8.

Referring to FIGS. 11C and 14C, it may be seen that the boundary between the white area WHA and the black area BKA does not appear in the captured image C_IMG22.

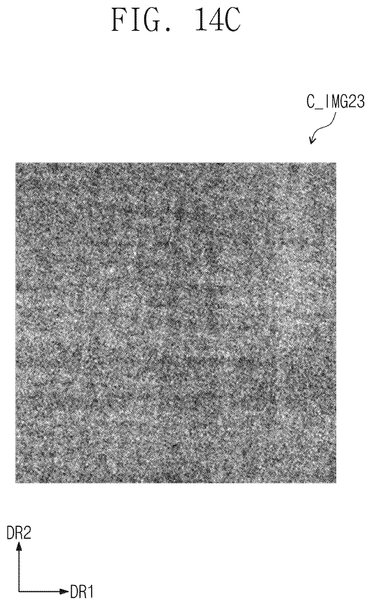

FIG. 15 illustrates the luminance of each of the captured images C_IMG21, C_IMG22, and C_IMG23 illustrated in FIGS. 14A, 14B, and 14C.

In FIG. 15, an eleventh line L11 indicates luminance corresponding to the captured image C_IMG21 illustrated in FIG. 14A when the driving controller 100 did not perform any compensation operation.

The luminance of the image displayed on the electronic device DD is indicated. A twelfth line L12 indicates the luminance corresponding to the captured image C_IMG22 illustrated in FIG. 14B when the driving controller 100 performs a deterioration compensation operation as illustrated in FIG. 6. The thirteenth line L13 indicates the luminance corresponding to the captured image C_IMG23 illustrated in FIG. 14C when the driving controller 100 performs the deterioration compensation operation based on the final compensation map F_MAP generated by the deterioration optical compensator 1000 illustrated in FIG. 8.

In FIG. 15, a horizontal axis indicates a location of the pixel PX in the first direction DR1 illustrated in FIGS. 14A, 14B, and 14C, and a vertical axis indicates luminance.

Referring to FIGS. 14A, 14B, 14C, and 15, in the case where the driving controller 100 does not perform any compensation operation, when the luminance for the target grayscale is set to 100%, the luminance of the white area WHA is lower than the luminance of the black area BKA. The reason is that the pixels PX (see FIG. 3) of the white area WHA are more degraded than the pixels PX of the black area BKA.

When the driving controller 100 performs the deterioration compensation operation as illustrated in FIG. 6, the luminance of the white area WHA is similar to the luminance of the black area BKA. However, deterioration overcompensation may occur at a boundary between the white area WHA and the black area BKA. In other words, near the boundary, the luminance of the black area BKA becomes higher than the luminance (100%) of the gray gradation, and the luminance of the white area WHA becomes lower than the luminance (100%) of the gray gradation.

When the driving controller 100 performs the deterioration compensation operation based on the final compensation map F_MAP generated by the deterioration optical compensator 1000, the luminance of the white area WHA is similar to the luminance of the black area BKA.

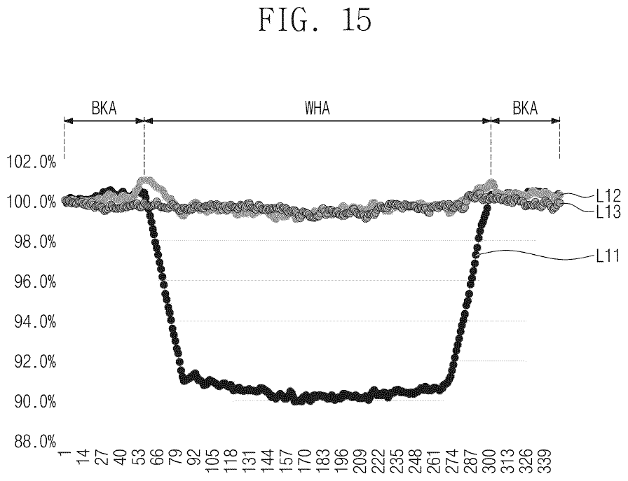

FIG. 16 is a block diagram of a deterioration optical compensator 2000, according to an embodiment of the present disclosure.

Referring to FIGS. 7 and 16, the deterioration optical compensator 2000 includes a captured-image receiver 2100, a feedback current receiver 2200, a captured-image corrector 2400, a deterioration area analyzer 2500, a first compensator 2600, a second compensator 2700, and a final compensation map generator 2800.

The captured-image receiver 2100 receives a captured image signal C_IMG from the image capture device CCD and outputs an imaging data signal C_DATA.

The feedback current receiver 2200 receives the feedback current signal FI from the display panel DP illustrated in FIG. 3 through the feedback line FL. The feedback current receiver 2200 outputs a feedback data signal F_DATA corresponding to the feedback current signal FI.

The captured-image corrector 2400 corrects the imaging data signal C_DATA with reference to the feedback data signal F_DATA and outputs the correction data signal COM P.

The feedback current signal FI includes deterioration information of the pixels PX. The captured-image corrector 2400 may correct the imaging data signal C_DATA with reference to the deterioration information included in the feedback current signal FI.

The deterioration area analyzer 2500 determines the deterioration area of the display panel DP (see FIG. 3) based on the correction data signal COMP and the feedback data signal F_DATA.

The deterioration area analyzer 2500 may divide the display panel DP into the normal area A1 and the deterioration area A2, as illustrated in FIG. 10D. The normal area A1 may be called a normal area with little deterioration. The deterioration area A2 may be called a deterioration area where deterioration has progressed significantly.

In an example in which the correction data signal COM P corresponds to the normal area A1, the deterioration area analyzer 2500 outputs the data signal D_DATA to the first compensator 2600. In an example in which the correction data signal COM P corresponds to the deterioration area A2, the deterioration area analyzer 2500 outputs the data signal D_DATA to the second compensator 2700. In an embodiment, the data signal D_DATA may be the same as the correction data signal COMP.

The first compensator 2600 outputs a first compensation value CV1 for compensating for the data signal D_DATA corresponding to the normal area A1. In an embodiment, the first compensator 2600 may output the first compensation value CV1 for compensating for the data signal D_DATA in units of blocks corresponding to the plurality of pixels PX. For example, one block may correspond to 8×8 of the pixels PX.

The second compensator 2700 outputs a second compensation value CV2 for compensating for the data signal D_DATA corresponding to the deterioration area A2. In an embodiment, the second compensator 1700 may output the second compensation value CV2 for compensating for the data signal D_DATA corresponding to each of the pixels PX. That is, the second compensation value CV2 may correspond to each of the pixels PX.

The final compensation map generator 2800 outputs a final compensation map F_MAP by combining the first compensation value CV1 corresponding to the normal area A1 and the second compensation value CV2 corresponding to the deterioration area A2. The final compensation map F_MAP may include a compensation value corresponding to each of the pixels PX of the display panel DP. The final compensation map F_MAP is provided to the electronic device DD.

The driving controller 100 (see FIG. 3) of the electronic device DD may output the image data signal DS by performing deterioration compensation on the input image signal RGB based on the final compensation map F_MAP.

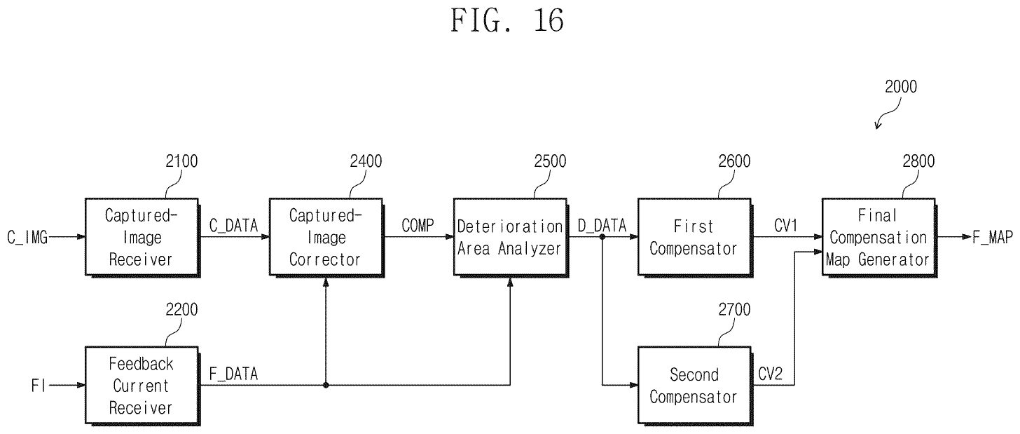

FIG. 17 is a block diagram of a driving controller 100_1, according to an embodiment of the present disclosure.

Referring to FIG. 17, the driving controller 100_1 includes a deterioration optical compensation unit 110 and a stain optical compensation unit 112.

The deterioration optical compensation unit 110 compensates for the input image signal RGB with reference to the final compensation map F_MAP provided from the deterioration optical compensator 1000 (see FIG. 8) and outputs a compensation image signal C_RGB.

The stain optical compensation unit 112 includes a lookup table for compensating for optical characteristic deviations between the pixels PX (see FIG. 3) during the production stage of the electronic device DD.

The stain optical compensation unit 112 performs stain optical compensation on the compensation image signal C_RGB and outputs the image data signal DS.

In an embodiment, each of the deterioration optical compensation unit 110 and the stain optical compensation unit 112 may be a software program, or a memory or a lookup table for storing the software program.

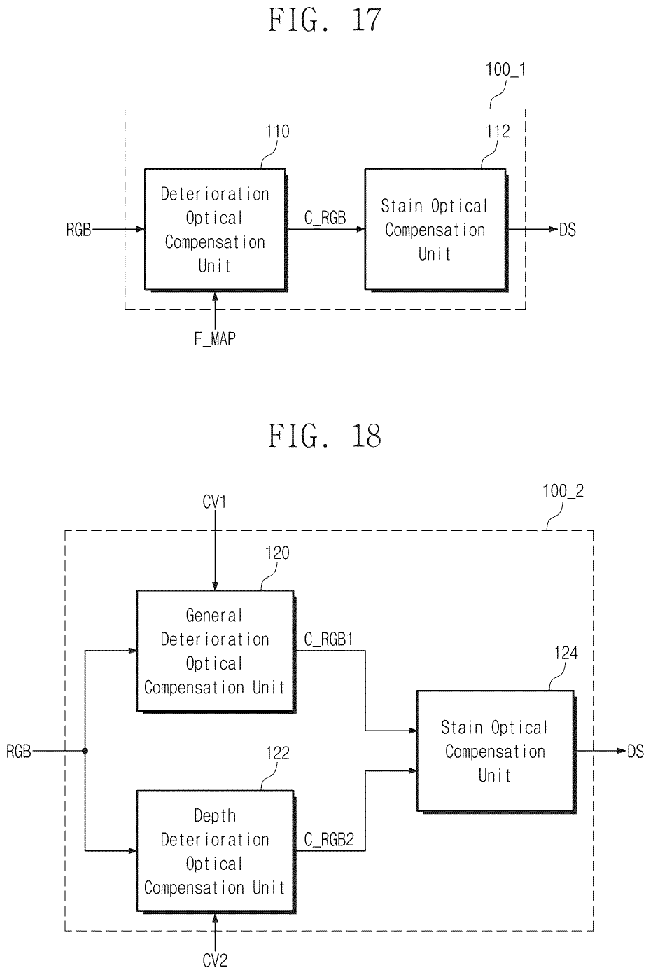

FIG. 18 is a block diagram of a driving controller 100_2, according to an embodiment of the present disclosure.

Referring to FIG. 18, the driving controller 100_2 includes a general deterioration optical compensation unit 120, a depth deterioration optical compensation unit 122, and a stain optical compensation unit 124.

The general deterioration optical compensation unit 120 compensates for the input image signal RGB corresponding to the normal area A1 (see FIG. 10D) of the input image signal RGB with reference to the first compensation value CV1 provided from the deterioration optical compensator 1000 (see FIG. 8) and outputs the first compensation image signal C_RGB1.

The depth deterioration optical compensation unit 122 compensates for the input image signal RGB corresponding to the deterioration area A2 (see FIG. 10D) of the input image signal RGB with reference to the second compensation value CV2 provided from the deterioration optical compensator 1000 (see FIG. 8) and outputs a second compensation image signal C_RGB2.

The stain optical compensation unit 124 includes a lookup table for compensating for optical characteristic deviations between the pixels PX (see FIG. 3) during the production stage of the electronic device DD.

The stain optical compensation unit 124 performs stain optical compensation on the first compensation image signal C_RGB1 and the second compensation image signal C_RGB2 and outputs the image data signal DS.

In an embodiment, each of the general deterioration optical compensation unit 120, the depth deterioration optical compensation unit 122, and the stain optical compensation unit 124 may be a software program, or a memory or a lookup table for storing the software program.

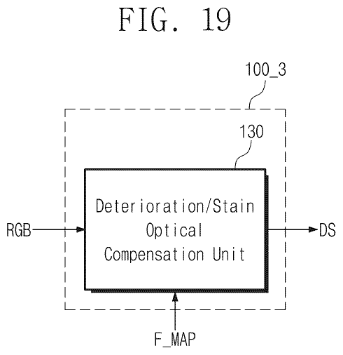

FIG. 19 is a block diagram of a driving controller 100_3, according to an embodiment of the present disclosure.

Referring to FIG. 19, the driving controller 100_3 includes a deterioration/stain optical compensation unit 130.

The deterioration/stain optical compensation unit 130 compensates for the input image signal RGB with reference to the final compensation map F_MAP provided from the deterioration optical compensator 1000 (see FIG. 8) and outputs the image data signal DS.

In an embodiment, the deterioration/stain optical compensation unit 130 has a form in which the deterioration optical compensation unit 110 and the stain optical compensation unit 112 illustrated in FIG. 17 are combined into one. The deterioration/stain optical compensation unit 130 may be a software program, or a memory or a lookup table for storing the software program.

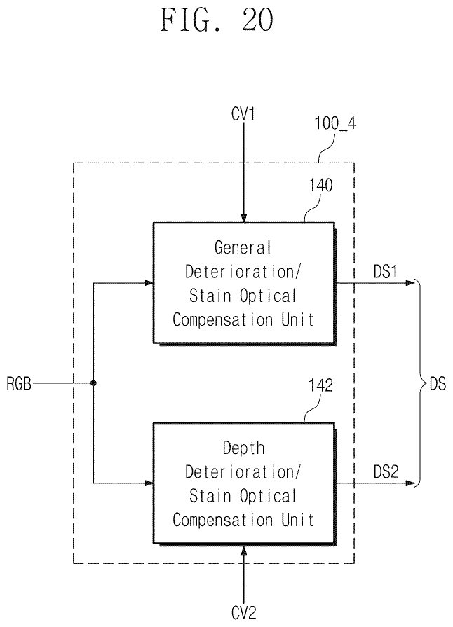

FIG. 20 is a block diagram of a driving controller 100_4, according to an embodiment of the present disclosure.

Referring to FIG. 20, the driving controller 100_4 includes a general deterioration/stain optical compensation unit 140 and a depth deterioration/stain optical compensation unit 142.

The general deterioration/stain optical compensation unit 140 compensates for the input image signal RGB corresponding to the normal area A1 (see FIG. 10D) of the input image signal RGB with reference to a stain optical compensation lookup table and the first compensation value CV1 provided from the deterioration optical compensator 1000 (see FIG. 8) and outputs a first image data signal DS1.

The depth deterioration/stain optical compensation unit 142 compensates for the input image signal RGB corresponding to the deterioration area A2 (see FIG. 10D) of the input image signal RGB with reference to the stain optical compensation lookup table and the second compensation value CV2 provided from the deterioration optical compensator 1000 (see FIG. 8) and outputs a second image data signal DS2. The first image data signal DS1 and the second image data signal DS2 may correspond to the image data signal DS illustrated in FIG. 3.

The stain optical compensation lookup table includes compensation values for compensating for optical characteristic deviations between the pixels PX (see FIG. 3) during the production stage of the electronic device DD.

In an embodiment, each of the general deterioration/stain optical compensation unit 140 and the depth deterioration/stain optical compensation unit 142 may be a software program, or a memory or a lookup table for storing the software program.

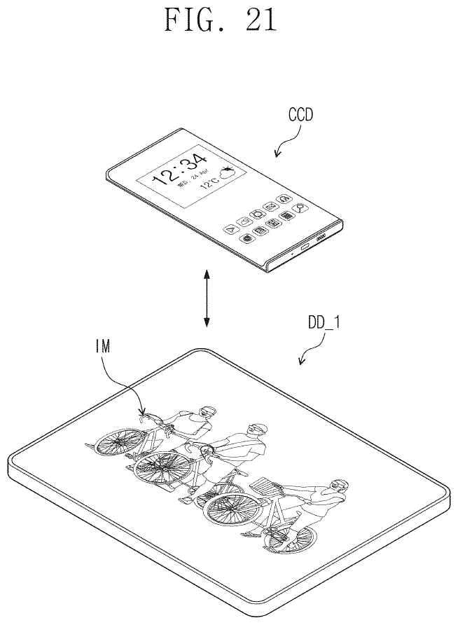

FIG. 21 is a diagram illustrating an optical compensation system, according to an embodiment of the present disclosure.

Referring to FIG. 21, the optical compensation system includes an electronic device DD_1 and the image capture device CCD.

The image capture device CCD is a device that includes a camera for capturing the image IM displayed on the electronic device DD_1. FIG. 21 illustrates a smart phone as an example of the image capture device CCD, but embodiments of the present disclosure are not limited thereto. The image capture device CCD may include various devices for capturing an image.

The electronic device DD_1 receives the captured image from the image capture device CCD. The electronic device DD_1 compensates for deterioration of the pixels PX (see FIG. 3) based on the captured image. The electronic device DD_1 illustrated in FIG. 21 may include the deterioration optical compensator 1000 illustrated in FIG. 7.

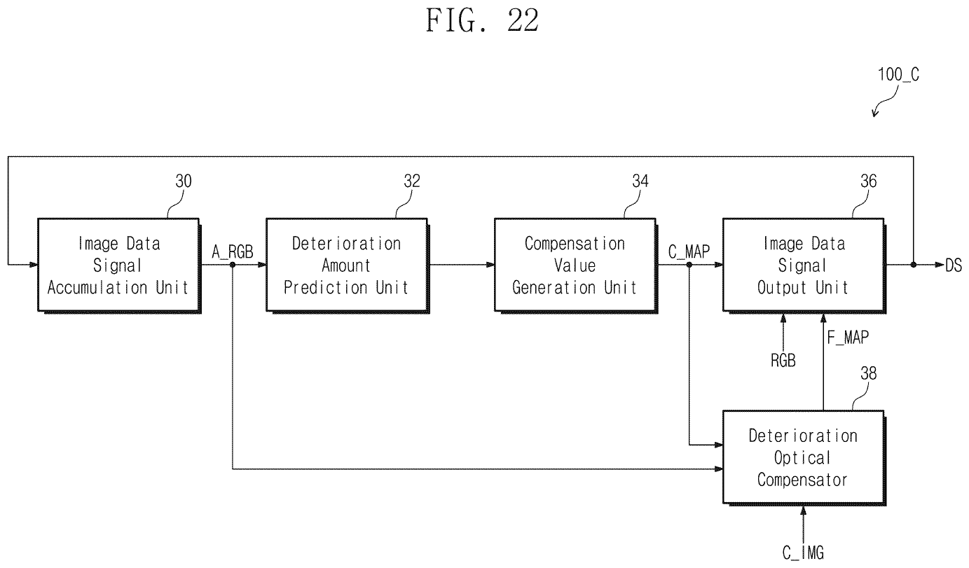

FIG. 22 is a block diagram illustrating a driving controller 100_C included in the electronic device DD_1 illustrated in FIG. 21.

The driving controller 100_C illustrated in FIG. 22 is illustrated as including configurations related to a deterioration compensation operation, but embodiments of the present disclosure are not limited thereto.

Referring to FIG. 22, the driving controller 100_C includes an image data signal accumulation unit 30, a deterioration amount prediction unit 32, a compensation value generation unit 34, and an image data signal output unit 36.

The image data signal accumulation unit 30 accumulates the image data signal DS and outputs an accumulation image signal A_RGB.

The deterioration amount prediction unit 32 predicts the deterioration amount of each of the pixels PX based on the accumulation image signal A_RGB.

The compensation value generation unit 34 generates a compensation value corresponding to each of the pixels PX based on the predicted deterioration amount of each of the pixels PX. In an embodiment, the compensation value generation unit 34 may generate a compensation map C_MAP by using the generated compensation value. The compensation map C_MAP may include information about a compensation value corresponding to each grayscale level of pixels.

A deterioration optical compensator 38 outputs the final compensation map F_MAP based on the accumulation image signal A_RGB, the compensation map C_MAP, and the captured image signal C_IMG from an image capture device CCD (see FIG. 21).

The deterioration optical compensator 38 has the same configuration as the deterioration optical compensator 1000 illustrated in FIG. 8 and may operate in the same manner.

The image data signal output unit 36 performs deterioration compensation based on the deterioration characteristics of each of the pixels PX. For example, the image data signal output unit 36 may output the image data signal DS by adding a compensation value corresponding to each of the pixels PX to the input image signal RGB with reference to the compensation map C_MAP and the final compensation map F_MAP.

In an embodiment, when the final compensation map F_MAP is not received from the deterioration optical compensator 38, the image data signal output unit 36 may convert the input image signal RGB into the image data signal DS with reference to the compensation map C_MAP. In an example in which the final compensation map F_MAP is received from the deterioration optical compensator 38, the image data signal output unit 36 may convert the input image signal RGB into the image data signal DS with reference to the final compensation map F_MAP as well as the compensation map C_MAP. For example, the image data signal output unit 36 may convert the input image signal RGB into an intermediate data signal with reference to the compensation map C_MAP and may convert the intermediate data signal into the image data signal DS with reference to the final compensation map F_MAP.

Although an embodiment of the present disclosure has been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

An electronic device having such the configuration may detect and compensate for changes in pixel characteristics during a usage step after it has been manufactured as a finished product. A compensation system of the electronic device may perform optical compensation by using not only accumulated deterioration data but also captured images, and thus compensation characteristics may be improved. In particular, the compensation system of the electronic device may further improve the compensation characteristics by performing depth compensation on a deterioration area on a pixel-by-pixel basis.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An optical compensation system comprising:
an electronic device comprising a plurality of pixels and which displays an image corresponding to an input image signal;
an image capture device which:
captures the image displayed on the electronic device; and
provides a captured image signal; and
a deterioration optical compensator which:
outputs a correction data signal, which is obtained by correcting the captured image signal based on an accumulation data signal from accumulating the input image signal, and
outputs a final compensation map for compensating for deterioration of the electronic device based on the correction data signal,
wherein the electronic device displays the image corresponding to the input image signal by performing a deterioration compensation operation based on the final compensation map.

2. The optical compensation system of claim 1, wherein the deterioration optical compensator:
divides the electronic device into a normal area and a deterioration area by determining a deterioration degree of each of the plurality of pixels based on the correction data signal, the accumulation data signal, and a compensation map provided from the electronic device;
generates a first compensation value for the normal area;
generates a second compensation value for the deterioration area; and
generates the final compensation map by combining the first compensation value and the second compensation value.

3. The optical compensation system of claim 2, wherein:
the deterioration optical compensator generates the first compensation value in units of blocks of the normal area based on the correction data signal,
the deterioration optical compensator generates the second compensation value in units of pixels of the deterioration area based on the correction data signal, and
each block corresponds to some pixels among the plurality of pixels.

4. The optical compensation system of claim 1, wherein the deterioration optical compensator comprises a captured-image corrector which:
determines first deterioration pixels among the plurality of pixels based on the accumulation data signal,
determines second deterioration pixels among the plurality of pixels based on the captured image signal, and
outputs the correction data signal, which is obtained by correcting the captured image signal based on comparing the first deterioration pixels and the second deterioration pixels.

5. The optical compensation system of claim 1, wherein the deterioration optical compensator comprises:
a deterioration area analyzer which:
determines a deterioration degree of each of the plurality of pixels based on the correction data signal, the accumulation data signal, and a compensation map provided from the electronic device,
divides the electronic device into a normal area and a deterioration area, and
outputs a data signal corresponding to the correction data signal;
a first compensator which outputs a first compensation value corresponding to the normal area, based on the data signal;
a second compensator which outputs a second compensation value corresponding to the deterioration area, based on the data signal; and
a final compensation map generator which generates the final compensation map by combining the first compensation value and the second compensation value.

6. The optical compensation system of claim 5, wherein the first compensator:
divides the normal area into a plurality of blocks, and
outputs the first compensation value corresponding to each of the plurality of blocks based on the data signal.

7. The optical compensation system of claim 5, wherein the second compensator outputs the second compensation value corresponding to each of the plurality of pixels of the deterioration area.

8. An optical compensation system comprising:
an electronic device comprising a plurality of pixels and which displays an image corresponding to an input image signal;
an image capture device which:
captures the image displayed on the electronic device; and
provides a captured image signal; and
a deterioration optical compensator which:
outputs a correction data signal, which is obtained by correcting the captured image signal based on a feedback current signal received from the plurality of pixels, and
outputs a final compensation map for compensating for deterioration of the electronic device based on the correction data signal,
wherein the electronic device displays the image corresponding to the input image signal by performing a deterioration compensation operation based on the final compensation map.

9. The optical compensation system of claim 8, wherein the deterioration optical compensator:
divides the electronic device into a normal area and a deterioration area by determining a deterioration degree of each of the plurality of pixels based on the correction data signal, the feedback current signal, and a compensation map provided from the electronic device;
generates a first compensation value for the normal area;
generates a second compensation value for the deterioration area; and
generates the final compensation map by combining the first compensation value and the second compensation value.

10. The optical compensation system of claim 9, wherein:
the deterioration optical compensator generates the first compensation value in units of blocks of the normal area based on the correction data signal,
the deterioration optical compensator generates the second compensation value in units of pixels of the deterioration area based on the correction data signal, and
each block corresponds to some pixels among the plurality of pixels.

11. The optical compensation system of claim 8, wherein the deterioration optical compensator comprises a captured-image corrector which:
determines first deterioration pixels among the plurality of pixels based on the feedback current signal,
determines second deterioration pixels among the plurality of pixels based on the captured image signal, and
outputs the correction data signal, which is obtained by correcting the captured image signal based on comparing the first deterioration pixels and the second deterioration pixels.

12. The optical compensation system of claim 8, wherein the deterioration optical compensator comprises:
a deterioration area analyzer which:
determines a deterioration degree of each of the plurality of pixels based on the correction data signal, the feedback current signal, and a compensation map provided from the electronic device,
divides the electronic device into a normal area and a deterioration area, and
outputs a data signal corresponding to the correction data signal;
a first compensator which outputs a first compensation value corresponding to the normal area, based on the data signal;
a second compensator which outputs a second compensation value corresponding to the deterioration area, based on the data signal; and
a final compensation map generator which generates the final compensation map by combining the first compensation value and the second compensation value.

13. The optical compensation system of claim 12, wherein the first compensator:
divides the normal area into a plurality of blocks, and
outputs the first compensation value corresponding to each of the plurality of blocks based on the data signal.

14. The optical compensation system of claim 12, wherein the second compensator outputs the second compensation value corresponding to each of the plurality of pixels of the deterioration area.

15. An electronic device comprising:
a display panel comprising a plurality of pixels; and
a driving controller which outputs an image data signal based on an input image signal and a captured image signal corresponding to an image displayed on the display panel,
wherein the driving controller comprises:
an image data signal accumulation unit which accumulates the image data signal and outputs an accumulation image signal;
a deterioration amount prediction unit which predicts a deterioration amount of each of the plurality of pixels based on the accumulation image signal;
a compensation value generation unit which generates a compensation map comprising a compensation value corresponding to each of the plurality of pixels based on the deterioration amount of each of the plurality of pixels;
a deterioration optical compensator which:
outputs a correction data signal, which is obtained by correcting the captured image signal based on the accumulation data signal, and
outputs a final compensation map for compensating for deterioration of the electronic device based on the correction data signal; and
an image data signal output unit which converts the input image signal into the image data signal based on the compensation map and the final compensation map.

16. The electronic device of claim 15, wherein the deterioration optical compensator:
divides the display panel into a normal area and a deterioration area by determining a deterioration degree of each of the plurality of pixels based on the correction data signal, the accumulation data signal, and the compensation map;
generates a first compensation value for the normal area;
generates a second compensation value for the deterioration area; and
generates the final compensation map by combining the first compensation value and the second compensation value.

17. The electronic device of claim 16, wherein:
the deterioration optical compensator generates the first compensation value in units of blocks of the normal area based on the correction data signal,
the deterioration optical compensator generates the second compensation value in units of pixels of the deterioration area based on the correction data signal, and
each block corresponds to some pixels among the plurality of pixels.

18. The electronic device of claim 15, wherein the deterioration optical compensator comprises a captured-image corrector which:
determines first deterioration pixels among the plurality of pixels based on the accumulation data signal,
determines second deterioration pixels among the plurality of pixels based on the captured image signal, and
outputs the correction data signal, which is obtained by correcting the captured image signal based on comparing the first deterioration pixels and the second deterioration pixels.

19. The electronic device of claim 15, wherein the deterioration optical compensator comprises:
a deterioration area analyzer which:
determines a deterioration degree of each of the plurality of pixels based on the correction data signal, the accumulation data signal, and a compensation map provided from the electronic device,
divides the electronic device into a normal area and a deterioration area, and
outputs a data signal corresponding to the correction data signal;
a first compensator which outputs a first compensation value corresponding to the normal area, based on the data signal;
a second compensator which outputs a second compensation value corresponding to the deterioration area, based on the data signal; and
a final compensation map generator which generates the final compensation map by combining the first compensation value and the second compensation value.

20. The electronic device of claim 19, wherein:
the first compensator:
divides the normal area into a plurality of blocks, and
outputs the first compensation value corresponding to each of the plurality of blocks based on the data signal, and
the second compensator outputs the second compensation value corresponding to each of the plurality of pixels of the deterioration area.
